(19) United States
(12) Patent Application Publication
(10) Pub. No.: US 2015/0286797 A1
(43) Pub. Date: Oct. 8, 2015

(54) System and method for administering medication

(71) Applicant: David R. Ratto, Arcadia, CA (US)

(72) Inventor: David R. Ratto, Arcadia, CA (US)

(21) Appl. No.: 13/999,910

(22) Filed: Apr. 2, 2014

(51) Int. Cl. G06F 19/00

(52) U.S. Cl. CPC G06F 19/3456; G06F 19/3418

(57) ABSTRACT

A system and method monitors patient biological indicator signals, analyzes the indicators and transmits control signals to patient medication administration devices according to the analysis of the signals.

### BACKGROUND

1. Field

Inventive concepts relate to the administration of medication, and, in particular, to automated administration of medication to patients.

2. Description of the Related Art

The proper administration of medication to a patient may require biological monitoring of the patient, along with application of the medication, over time, in response to biological indications. Under some circumstances a patient may require medication administered under relatively close supervision. That is, a patient's condition may require that a medication be administered, the effects of the administered medication monitored, and, if the monitoring indicates, adjustments to the level and/or frequency of application of the medication be made over a relatively short time frame.

A patient may be in a critical state that requires another to monitor their condition and apply medication as indicated by the patient's condition. For example, a patient may be in cardiac or septic shock, in an altered mental state, in an extreme hypertensive state following a stroke, or in a state of congestive heart failure that requires close monitoring and appropriate application of medications. Such patients may be receiving the medications to support body functions while other measures are being initiated, such as in emergency room, or other such settings.

Patients in such a state are often ministered to by nurses, who must monitor patient signs and trends and apply medications according to those signs and trends. The nurse makes observations, notes trends, and adjusts medications. There are many opportunities for error in such a situation. Each nurse may be responsible for a number of patients and, as a result, may be unable to closely monitor each patient. Even without error, there may be a great deal of variability in observation, in trend-spotting and in decision-making, from nurse to nurse, and from time to time with the same nurse. There may be a wide variation in the dosage of medications, based on each nurse's observations and judgment. Each nurse may administer medication at a different rate. And the point at which each nurse adjusts medications may vary.

### SUMMARY

In accordance with principles of inventive concepts, a method includes a processor receiving a signal from a patient monitor indicative of a patient's biological functioning, the processor analyzing the signal received from the patient monitor, and the processor transmitting a control signal to a patient medication delivery device based upon the analysis of the patient monitor signal.

In accordance with principles of inventive concepts, a method includes a processor receiving a signal indicative of a patient's blood pressure.

In accordance with principles of inventive concepts, a processor analyzes the blood pressure signal to determine whether the patient's blood pressure falls within an acceptable range.

In accordance with principles of inventive concepts, a processor transmits a control signal to the patient medication delivery system to increase the level of a medication if the patient's blood pressure is higher than a threshold level for a predetermined number of readings.

In accordance with principles of inventive concepts, a processor transmits a control signal to the patient medication delivery system to increase the level of a medication if the patient's blood pressure is lower than a threshold level for a predetermined number of readings.

In accordance with principles of inventive concepts, the medication is a vasodilator.

In accordance with principles of inventive concepts, the medication is a vasopressor.

In accordance with principles of inventive concepts, a processor sets an alarm if the analysis determines that the patient biological signal meets a threshold level for the alarm.

In accordance with principles of inventive concepts, a processor records biological readings.

In accordance with principles of inventive concepts, a processor transmits biological readings.

### BRIEF DESCRIPTION OF THE DRAWINGS

The above and other features and advantages of inventive concepts will become more apparent by describing in detail preferred embodiments thereof with reference to the attached drawings in which:

FIG. 1 is a block diagram of a medication administration system in accordance with principles of inventive concepts;

FIG. 2 is a flow chart that depicts operation of a medication administration system in accordance with principles of inventive concepts;

and

FIG. 3 is a system diagram of a controller that may be used in a system and method in accordance with principles of inventive concepts.

### DESCRIPTION

Advantages and features of inventive concepts and methods of accomplishing the same may be understood more readily by reference to the following detailed description of preferred embodiments and the accompanying drawings. Inventive concepts may, however, be embodied in many different forms and should not be construed as being limited to the embodiments set forth herein. Rather, these embodiments are provided so that this disclosure will be thorough and complete and will fully convey the concept of inventive concepts to those skilled in the art, and the present inventive concepts will only be defined by the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

It will be understood that, although the terms first, second, etc. may be used herein to describe various elements, these elements should not be limited by these terms. These terms are only used to distinguish one element from another element. Thus, for example, a first element, a first component, first step, or a first section discussed below could be termed a second element, a second component, second step, or a second section without departing from the teachings of inventive concepts.

Unless defined otherwise, all technical and scientific terms used herein have the same meaning as commonly understood by one of ordinary skill in the art to which inventive concepts belong. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

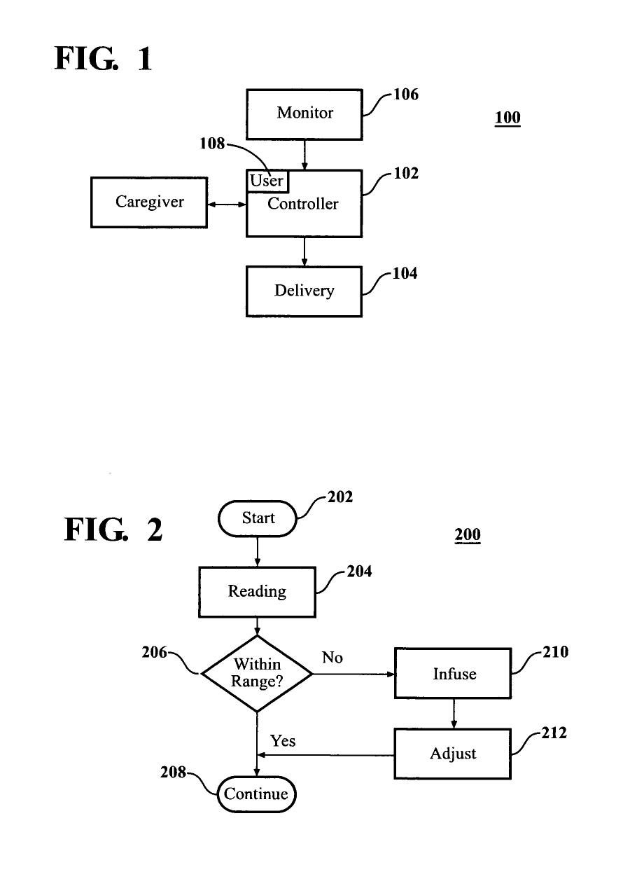

The block diagram of FIG. 1 depicts an exemplary embodiment of an automated medication system 100 in accordance with principles of inventive concepts. System 100 includes a medication controller 102 that provide control signals to an electronic medication delivery device 104, such as an infusion pump, and receives patient biological information from an electronic patient monitoring device 106, such as a pulse oximeter, for example. As will be described in detail in the description related to the following figures, medication controller 102 may monitor patient biological readings received from an electronic patient monitoring device 106 and, based on patient information thus-obtained, control the delivery of medication to a patient through an electronic medication delivery device 104, thereby alleviating the burden of caregivers and allowing caregivers to focus on other aspects of their operation. As will be described in greater detail below, in accordance with principles of inventive concepts, various levels of control may be implemented using controller 102, monitoring and patient-trend analysis may be provided, and patient-data logging and reporting may also be provided. A user interface 108 allows a responsible party to interact with the system 100, to observe system operation, to observe patient trends, and to intervene, reset, or override system operation, with appropriate security access.

The flow chart of FIG. 2 illustrates an exemplary embodiment of a patient monitoring and medication delivery process in accordance with principles of inventive concepts. In an exemplary embodiment in accordance with principles of inventive concepts, one or more of a patient's vital signs may be automatically monitored and, depending upon the readings, one or more medications, such as vasoactive medications, may be delivered to the patient. Although all patients may benefit from the use of a system and method in accordance with principles of inventive concepts, such a system and method are particularly suited to lifesaving, that is, for patients experiencing extreme medical conditions wherein medications are necessary to support body functions. Such patients may be in cardiac or septic shock, with inadequate perfusion of body organs, or, their blood pressure may be excessive, which may lead to stroke, or the patient may be experiencing altered mental states or congestive heart failure, for example.

Patients requiring lifesaving vasoactive medications typically have a baseline medication infusion level that takes into account one or more biological factors, such as weight, for example. However, the patient's vital signs must be closely monitored and infusion levels adjusted as necessary to maintain or improve the vital signs. In conventional approaches, monitoring and adjustment of infusion levels may be performed by a nurse, for example, who will often be caring for more than one patient. The nurse must take readings (blood pressure, for example) for each patient under her care, monitor trends in those readings, and adjust medications in response to the readings. The frequency with which readings are taken, trends observed, and medication adjustments made, may often be determined by a relatively vague set of guidelines. As a result, there may be wide variations in the dosage a patient receives, depending upon different nurse's judgments. Because patients are receiving critical care, emergency situations may arise for one patient that distracts a nurse from monitoring another patient. Different blood pressure levels may be used by different nurses as triggers for adjusting medications. The degree of change and rate of change of medication adjustment may vary among caregivers, and errors may be made in calculating doses and adjustments of doses.

By automating both monitoring and medication-infusion in accordance with principles of inventive concepts, nurses may be freed to perform other critical functions, patient readings and reading trends may be more accurately monitored, and medications adjusted more precisely than if these functions were performed purely manually, resulting in better patient outcomes.

A patient monitoring and infusing method in accordance with principles of inventive concepts begins in step 200 where initial conditions, including initial medication levels and initial measurement frequency, are established for the patient. Such initial conditions may be established, for example, using the patient's weight and initial blood pressure readings, for example. This information may be entered into a system in accordance with principles of inventive concepts.

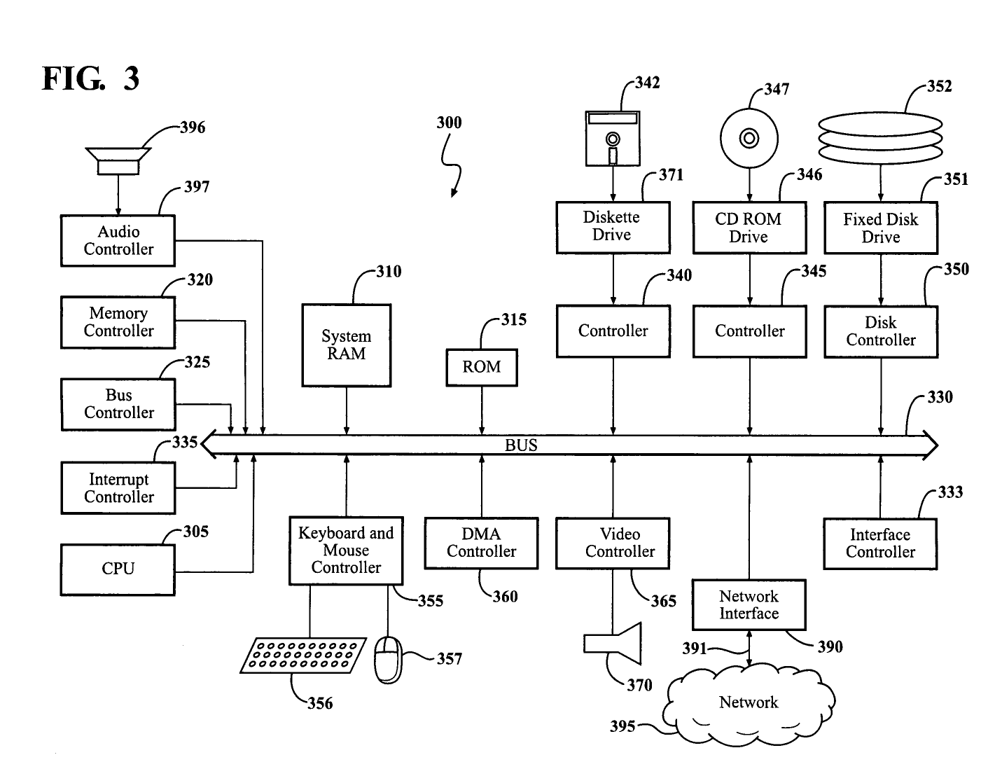

Once initial conditions are established in step 200, the process proceeds from there to step 202, where a patient reading is taken. The reading may be a blood pressure reading or oxygen level reading, for example. Blood pressure readings may be performed by an electronic sphygmomanometer, standard pressure cuff, or arterial line, for example. Blood oxygen levels may be measured by electronic oximeter, for example. In accordance with principles of inventive concepts, such blood pressure and oxygen measurements may be performed by a device that provides an electronic signal indicative of the reading which can be interpreted by a controller, such as controller 102, described in the discussion related to FIG. 1 and in greater detail in the discussion related to FIG. 3. Such electronic signals may be analog or digital and may be formatted according to a communications standard or may be proprietary, for example. An infusion pump that may be employed in a system in accordance with principles of inventive concepts is described in U.S. Pat. No. 8,291,337 issued to Gannin et al. A system and method in accordance with principles of inventive concepts may employ an electronic sphygmomanometer such as the Nova Plus® model available from Welch Allen, and an electronic pulse oximeter, available from Massimo, may be used by a system and method in accordance with principles of inventive concepts. However, these are simply exemplary embodiments and a variety of infusion pumps, pulse oximeters, and sphygmomanometers capable of electronic communications with a controller 102 may be employed in a system and method in accordance with principles of inventive concepts. Controller 102 may store patient readings, determine trends in the readings, display measurements and trends, and set alarms, for example. Such alarms may be local or remote alarms and may include both visual and audio indications. Alarms, patient readings, and trends may be stored locally or communicated, via a private network, wireless link, Bluetooth, infrared link, or via the Internet, for example, to a central facility for response, storage, and analysis.

The initial patient reading of step 204 may be taken immediately after the patient is connected (that is, all monitoring devices 106 are attached to the patient and to the controller 102 and all to the system 100 and all delivery devices are connected to the patient and to the controller 102) and the system may perform a self-test and/or calibration once connected, for example. Subsequent measurements may commence at a preset time interval, for example. In exemplary embodiments in accordance with principles of inventive concepts, an initial dosage may be determined purely on the basis of a patient's weight. A medication such as dopamine may be administered at a dosage of 10 μg per Kilogram of patient's weight per minute.

From step 204 the process proceeds to step 206 where the patient reading, such as a blood pressure reading, is analyzed to determine whether it falls within an acceptable range or, if it does not, whether it is too high or too low. Although other patient readings and associated medications may be employed in accordance with principles of inventive concepts, further discussion will be limited primarily to the application of inventive concepts to monitoring and treating patient blood pressure. If, in step 206, the system 100 determines that the reading is within an acceptable range, the patient's dosage is not modified, the frequency of measurements is maintained, and medications are delivered to the patient according the initial scheme, determined in step 202. The process proceeds to continue in step 208, repeating measurements and infusion of medications until the patient moves on to a different protocol.

On the other hand, if the system 100 determines in step 206 that the blood pressure measurement is not within an acceptable range, the process proceeds to step 210, where the patient is infused with mediation by controller 100 transmitting control signals to medication delivery system 104, which may be implemented as an infusion pump, for example. From step 210 the process proceeds to step 212, where adjustments are made to the infusion process, following a predetermined schedule. Such as schedule may be one that is provided by a system and method in accordance with principles of inventive concepts, for example. Such as schedule may be tailored to the characteristics of an individual patient, taking into account, age, weight, gender, etc. Such information may be received by the system 100 through a system interface, such graphical system user interface, or may be downloaded from a central database, such as a hospital or clinic database, for example. Once the adjustment process is completed in step 212, the process proceeds to continue in step 208, and from there as previously described.

A more detailed exemplary embodiment of a system and method in accordance with principles of inventive concepts may include taking patient readings at a rate that reflects the current state of a patient. That is, a controller 102 may direct a monitor 106 (for example, an electronic sphygmomanometer) to gather data from a patient on a more frequent basis if a recent patient reading falls outside the boundary of what may be acceptable. In exemplary embodiments in accordance with principles of inventive concepts, controller 102 induces an electronic sphygmomanometer to obtain patient blood pressure readings at a base rate if the patient's blood pressure readings are at or above a threshold level, but obtains readings more frequently if the blood pressure readings are below the threshold level. In exemplary embodiments in accordance with principles of inventive concepts, the threshold blood pressure levels are: 1) below acceptable range, mean pressure less than 60 to 65 mmHg, systolic pressure less than 90 mmHg; 2) above acceptable range, mean pressure greater than 90 mmHg, systolic blood pressure greater than 150 mmHg, 3) acceptable range between the two. In exemplary embodiments in accordance with principles of inventive concepts, the base rate for measurements falls within a range of from three to ten minutes. More frequent measurements, in the case of low blood pressure readings, may be performed within the range of every one to three minutes, for example.

Dose changes may also reflect the current state of the patient, in that, for example, a patient with a low blood pressure reading may have his dosage modified more frequently than a patient with acceptable blood pressure readings. For example, a patient with low blood pressure reading may have his dosage modified at a frequency from every ten times a reading is taken down to every time a reading is taken. That is, the dosage may be adjusted after only one unsatisfactory reading, or the process may wait for more than one unsatisfactory reading before adjusting the dosage. A patient with acceptable blood pressure reading may have his dosage maintained at the current level. And, a patient with blood pressure readings above an acceptable range may have his dosage modified at a frequency from every twenty to every three measurements, for example. That is, the process may modify dosage immediately when an unacceptable pressure reading (a reading, that is, that falls outside a preferred range, but is not at a critical level that would set off an alarm) is made or may wait for additional unacceptable readings (up to twenty readings), for example.

By “unacceptable pressure reading” we mean a reading that falls outside a preferred range of pressures, not a reading that is at a critical level. Readings at or beyond critical levels would trigger an alarm which may be local, and/or transmitted to a nurses' station, for example. The level at which alarms are sounded may be determined and set within the system, for example, by a physician, nurse, technician, according to commonly accepted medical procedures, hospital standards, or other standards, for example. Preset alarms, such as those employed by monitoring systems such as those available from Welch Allyn or Hewlett-Packard, may be employed by as system in accordance with principles of concepts, for example.

Typically, with low blood pressure, which may indicate that a patient has entered a state of shock, a vasopressor may be administered and the dosage may be increased if the patient remains in a low pressure state for a designated number of measurements. With high blood pressure, a vasodilator may be administered. As described above, a starting dosage for a vasoactive medication such as dopamine, may be 10 μg per kilogram of patient weight per minute. Blood pressure may be recorded every 5 to 15 minutes, with a maximum interval of 120 minutes. For low blood pressure a mean arterial pressure (MAP) less than 65, a titration rate increase may be set at between 3 and 5 μg per kilogram per minute, with a maximum dose set at between 20 and 60 μg per kilogram per minute. In exemplary embodiments in accordance with principles of inventive concepts, titration of vasoactive medications may include dose changes in the range of from 0 to 20 μg rate changes from 0 to 100 mL per hour, time intervals from 0 to 2 hours and the number of intervals measured may be from 1 to 60, for example. Blood pressure may be systolic, diastolic, or mean arterial pressure, for example.

In exemplary embodiments in accordance with principles of inventive concepts, norepinephrine may be administered for a patient in shock. A typical starting dose may be 4 to 10 μg/minute Blood pressure may be measured every 5 to 15 minutes In accordance with principles of inventive concepts, norepinephrine may be increased when a MAP reading is less than 65 mm/Hg and may be increased by an amount of 2 μg/minute every 15 minutes, over a period of from 15 minutes to 60 minutes, for example. With a MAP of from 65 to 90 mm/Hg, no adjustments to the initial, base, infusion rate will be made. If the MAP is greater than 90 mm/Hg, the infusion levels will be decreased by 1 μg/minute, every 60 minutes. Medication may be reduced by 1 μg/Kg (ranging between 1-5, for example), for MAP greater than 65 every 30 minutes. A maximum dosage may be set at 60 μg/minute, for example. In a situation where a patient exhibits high blood pressure, which may be associated with intracerebral hemorrhage, for example, as system and method in accordance with principles of inventive concepts may administer a vasodilator, such as Nicardipine. In such a situation a patient may exhibit a systolic blood pressure measurement of, for example, 240/140 systolic/diastolic. In accordance with principles of inventive concepts, a starting dosage may be 5 mg/hr. Blood pressure may be measured every 5 to 15 minutes, for example. A systolic blood pressure greater than 180 mmHg would trigger a system in accordance with principles of inventive concepts to increase the level of Nicardipine by 2.5 mg every 15 minutes. With blood pressures in the range of from 150 mmHg to 180 mmHg, the dosage of Nicardipine would not change. In cases where systolic blood pressure is less than 150 mmHg, the dosage may be decreased at a rate of 2.5 mg/hour every fifteen minutes. In exemplary embodiments, the maximum amount of Nicardipine administered to a patient may be set at 15 mg/hr.

FIG. 3 illustrates the system architecture for a computer system 300 on which a portion of the invention may be implemented. The exemplary computer system of FIG. 3 is for descriptive purposes only. Although the description may refer to terms commonly used in describing particular computer systems, the description and concepts equally apply to other systems, including systems having architectures dissimilar to FIG. 3.

Computer system 300 includes a central processing unit (CPU) 305, which may be implemented with a conventional microprocessor, a random access memory (RAM) 310 for temporary storage of information, and a read only memory (ROM) 315 for permanent storage of information. A memory controller 320 is provided for controlling RAM 310.

A bus 330 interconnects the components of computer system 300. A bus controller 325 is provided for controlling bus 330. An interrupt controller 335 is used for receiving and processing various interrupt signals from the system components.

Mass storage may be provided by diskette 342, CD ROM 347, or hard drive 352. Data and software may be exchanged with computer system 300 via removable media such as diskette 342 and CD ROM 347. Diskette 342 is insertable into diskette drive 341 which is, in turn, connected to bus 330 by a controller 340. Similarly, CD ROM 347 is insertable into CD ROM drive 346 which is, in turn, connected to bus 330 by controller 345. Hard disc 352 is part of a fixed disc drive 351 which is connected to bus 330 by controller 350.

User input to computer system 300 may be provided by a number of devices. For example, a keyboard 356 and mouse 357 are connected to bus 330 by controller 355. An audio transducer 396, which may act as both a microphone and a speaker, is connected to bus 330 by audio controller 397, as illustrated. It will be obvious to those reasonably skilled in the art that other input devices, such as a pen and/or tabloid may be connected to bus 330 and an appropriate controller and software, as required. DMA controller 360 is provided for performing direct memory access to RAM 310. A visual display is generated by video controller 365 which controls video display 370. Computer system 300 also includes a communications adaptor 390 which allows the system to be interconnected to a local area network (LAN) or a wide area network (WAN), schematically illustrated by bus 391 and network 395. An input interface 399 operates in conjunction with an input device 393 to permit a user to send information, whether command and control, data, or other types of information, to the system 300. The input device and interface may be any of a number of common interface devices, such as a joystick, a touch-pad, a touch-screen, a speech-recognition device, or other known input device.

Operation of computer system 300 is generally controlled and coordinated by operating system software. The operating system controls allocation of system resources and performs tasks such as processing scheduling, memory management, networking, and I/O services, among things. In particular, an operating system resident in system memory and running on CPU 305 coordinates the operation of the other elements of computer system 300. The present invention may be implemented with any number of operating systems, including commercially available operating systems. One or more applications, such may also run on the CPU 305. If the operating system is a true multitasking operating system, multiple applications may execute simultaneously. An interface controller 333 may be employed, for example, to communicate with the controller 600.

While inventive concepts have been particularly shown and described with reference to exemplary embodiments thereof, it will be understood by those of ordinary skill in the art that various changes in form and details may be made therein without departing from the spirit and scope of inventive concepts as defined by the following claims. It is therefore desired that the present embodiments be considered in all respects as illustrative and not restrictive, reference being made to the appended claims rather than the foregoing description to indicate the scope of the invention.

What is claimed is:

1. A method, comprising:
a processor receiving a signal from a patient monitor indicative of a patient's biological functioning;
the processor analyzing the signal received from the patient monitor; and
the processor transmitting a control signal to a patient medication delivery device based upon the analysis of the patient monitor signal.

2. The method of claim 1, wherein the processor receives a signal indicative of a patient's blood pressure.

3. The method of claim 2, wherein the processor analyzes the blood pressure signal to determine whether the patient's blood pressure falls within an acceptable range.

4. The method of claim 3, wherein the processor transmits a control signal to the patient medication delivery system to increase the level of a medication if the patient's blood pressure is higher than a threshold level for a predetermined number of readings.

5. The method of claim 3, wherein the processor transmits a control signal to the patient medication delivery system to increase the level of a medication if the patient's blood pressure is lower than a threshold level for a predetermined number of readings.

6. The method of claim 4, wherein the medication is a vasodilator.

7. The method of claim 5, wherein the medication is a vasopressor.

8. The method of claim 1, further comprising the processor setting an alarm if the analysis determines that the patient biological signal meets a threshold level for the alarm.

9. The method of claim 1, further comprising the processor recording biological readings.

10. The method of claim 1, further comprising the processor transmitting biological readings.

11. An apparatus, comprising:
a processor configured to receive a signal from a patient monitor indicative of a patient's biological functioning;
the processor configured to analyze the signal received from the patient monitor; and
the processor configured to transmit a control signal to a patient medication delivery device based upon the analysis of the patient monitor signal.

12. The apparatus of claim 11, wherein the processor is configured to receives a signal indicative of a patient's blood pressure.

13. The apparatus of claim 12, wherein the processor is configured to analyze the blood pressure signal to determine whether the patient's blood pressure falls within an acceptable range.

14. The apparatus of claim 13, wherein the processor is configured to transmit a control signal to the patient medication delivery system to increase the level of a medication if the patient's blood pressure is higher than a threshold level for a predetermined number of readings.

15. The apparatus of claim 13, wherein the processor is configured to transmit a control signal to the patient medication delivery system to increase the level of a medication if the patient's blood pressure is lower than a threshold level for a predetermined number of readings.

16. The apparatus of claim 14, wherein the medication is a vasodilator.

17. The apparatus of claim 15, wherein the medication is a vasopressor.

18. The apparatus of claim 11, further comprising the processor configured to set an alarm if the analysis determines that the patient biological signal meets a threshold level for the alarm.

19. The apparatus of claim 11, further comprising the processor configured to record biological readings.

20. The apparatus of claim 11, further comprising the processor configured to transmit biological readings.
